(19) United States
(12) Patent Application Publication
(10) Pub. No.: US 2003/0035608 A1
(43) Pub. Date: Feb. 20, 2003

(54) Multi-channel compensation of chromatic dispersion slope using etalons with wavelength dependent variable reflectivity

(76) Inventors: Qin Zhang, San Jose, CA (US); Jianzhong Zhang, Palo Alto, CA (US); Jason T. Yang, Cupertino, CA (US)

Correspondence Address: FENWICK & WEST LLP, TWO PALO ALTO SQUARE, PALO ALTO, CA, 94306, US

(21) Appl. No.: 10/215,559

(22) Filed: Aug. 9, 2002

Related U.S. Application Data
(63) Continuation-in-part of application No. 10/099,413, filed on Mar. 15, 2002.
(60) Provisional application No. 60/311,498, filed on Aug. 10, 2001.

(51) Int. Cl. G02B 6/26

(52) U.S. Cl. 385/15; 385/27

(57) ABSTRACT

A dispersion compensation system includes a number of etalons cascaded in series to form a chain. The chain of etalons introduces a cumulative group delay that compensates for chomatic dispersion and dispersion slope. At least one of the etalons is tunable, thus allowing the system to be turned, for example to compensate for different amounts of dispersion and/or manufacturing variations.

### CROSS-REFERENCE TO RELATED APPLICATIONS

This application is a continuation-in-part of co-pending U.S. patent application Ser. No. 10/099,413, “Compensation of Chromatic Dispersion Using Cascaded Etalons of Variable Reflectivity,” by Qin Zhang and Jason T. Yang, filed Mar. 15, 2002.

This application is related to co-pending U.S. patent application Ser. No. 10/087,087, “Etalons with Variable Reflectivity,” by Qin Zhang, filed Feb. 27, 2002.

This application claims priority under 35 U.S.C. § 119(e) to U.S. Provisional Patent Application Serial No. 60/311,498, “Method and Apparatus for Tunable Chromatic Dispersion Based on Gradient Reflectivity Etalons,” by Qin Zhang and Jason T. Yang, filed Aug. 10, 2001.

The subject matter of all of the foregoing is incorporated herein by reference in its entirety.

### BACKGROUND OF THE INVENTION

1. Field of the Invention

This invention relates generally to compensation of chromatic dispersion and dispersion slope. More specifically, this invention relates to the use of etalons to compensate for chromatic dispersion slope.

2. Description of the Related Art

As the result of recent advances in technology and an ever-increasing demand for communications bandwidth, there is increasing interest in optical communications systems, especially fiber optic communications systems. This is because optical fiber is a transmission medium that is well-suited to meet the demand for bandwidth. Optical fiber has a bandwidth which is inherently broader than its electrical counterparts. At the same time, advances in technology have increased the performance, increased the reliability and reduced the cost of the components used in fiber optic systems. In addition, there is a growing installed base of laid fiber and infrastructure to support and service the fiber.

However, even fiber optic systems have limits on price and performance. Chromatic dispersion is one basic phenomenon which limits the performance of optical fibers. The speed of a photon traveling along an optical fiber depends on the index of refraction of the fiber. Because the index of refraction is slightly dependent on the frequency of light, photons of different frequencies propagate at different speeds. This effect is commonly known as chromatic dispersion. Chromatic dispersion causes optical signal pulses to broaden in the time domain. In addition, chromatic dispersion is cumulative in nature. Therefore, optical signals which travel longer distances will experience more chromatic dispersion. This limits the signal transmission distance over which high bit rate signals can be transmitted, even with the use of narrow linewidth lasers and low chirp external modulators. For instance, signals at 10 Gbps can travel roughly 80 km in a standard SMF-28 single mode fiber before adjacent digital bits start to interfere with each other. At 40 Gbps, this distance is reduced to 6 km. Chromatic dispersion is a significant problem in implementing high speed optical networks.

Several different approaches have been proposed to compensate for the effects of chromatic dispersion and, therefore, extend the signal transmission distance. They include systems based on dispersion compensating fiber, fiber Bragg gratings, photonic integrated circuits and etalons.

Dispersion compensating fibers (DCF) are optical fibers which have chromatic dispersion which is opposite in sign to the chromatic dispersion in “normal” fibers. Thus, propagation through a length of DCF cancels the chromatic dispersion which results from propagating through standard single mode fiber. At the present time, DCF is one of the leading commercial technologies for the compensation of chromatic dispersion and a significant number of chromatic dispersion compensating devices is based on DCF. However, DCF has several significant disadvantages. First, long lengths of DCF are required to compensate for standard fiber. For example, a typical application might require 1 km of DCF for every 5 km of standard fiber. Thus, 100 km of standard fiber would require 20 km of DCF. These amounts of DCF are both expensive and bulky. Second, DCF solutions are static. A 20 km length of DCF will introduce a specific amount of dispersion compensation. If more or less is required, for example due to changes in the overall network architecture, a different DCF solution must be engineered. The existing 20 km of DCF cannot be easily “tuned” to realize a different amount of dispersion compensation, making it unsuitable for agile telecommunications network applications. Third, DCF is a type of fiber and suffers from many undesirable fiber characteristics, typically including undesirable fiber nonlinearities and high losses. A 20 km length of fiber can introduce significant losses. Fourth, standard single mode fibers have non-uniform dispersion values over a wide bandwidth, resulting in a second-order dispersion effect commonly referred to as dispersion slope. DCF solutions typically do not do a good job in compensating for dispersion slope, leaving behind some uncompensated residual dispersion.

Fiber Bragg gratings (FBG) have emerged over the past few years as a promising candidate for the compensation of chromatic dispersion. A fiber Bragg grating is a length of fiber into which Bragg gratings have been formed. Various groups have proposed different architectures for using FBGs to compensate for chromatic dispersion. For example, see FIG. 1 in C. K. Madsen and G. Lenz, “Optical all-pass filters for phase response design with applications for dispersion compensation,” IEEE Photonics Technology Letters, vol. 10, no. 7, July 1998, pp. 994-996. However, practical implementation of FBG solutions remains difficult. Engineering limitations have resulted in less than acceptable dispersion compensation. Finding reproducible and reliable processes to make a dispersion compensator based on FBGs remains very challenging. In addition, Bragg gratings are inherently narrow band devices so FBG-based dispersion compensators typically have a narrow operating bandwidth. It is also difficult to tune FBGs to achieve different amounts of dispersion compensation.

Architectures based on planar waveguides have also been proposed. For example, the paper referenced above suggests an approach for compensating for chromatic dispersion using an all-pass filter approach based on ring structures in planar waveguides. However, this approach is inherently expensive and polarization sensitive.

Finally, around 1990, it was disclosed that the phase response of a single etalon has a nonlinear relationship with frequency. See L. J. Cimini Jr., L. J. Greenstein and A. A. M. Saleh, “Optical equalization to combat the effects of laser chirp and fiber dispersion,” J. Lightwave Technology, vol. 8, no. 5, May 1990, pp. 649-659. Furthermore, it was proposed that an etalon could be used to compensate for chromatic dispersion. Since that time, various etalon-based architectures have been suggested. However, most, if not all, of these architectures suffer from significant drawbacks. Many of them simply cannot attain the necessary performance. They often suffer from too much group delay ripple (e.g., >20 ps) and/or too narrow an operating bandwidth. In addition, most, if not all, designs are static. The designs cannot be easily tuned to achieve different amounts of dispersion compensation. In addition, they typically do not adequately compensate for dispersion slope.

Thus, there is a need for dispersion compensation systems which can be tuned to achieve different amounts of dispersion slope compensation. It is also desirable for these systems to operate over a large bandwidth and to be capable of achieving low group delay ripple.

### SUMMARY OF THE INVENTION

The present invention overcomes the limitations of the prior art by providing a dispersion compensation system in which a number of etalons are cascaded in series to form a chain. The chain of etalons introduces a cumulative group delay that compensates for chromatic dispersion. At least one of the etalons is tunable, thus allowing the system to be tuned, for example to compensate for different amounts of dispersion slope and/or manufacturing variations.

In one implementation, the dispersion compensation system includes a chain of at least one etalon stage. Each etalon stage includes an input port, an output port, an optical path from the input port to the output port; and an etalon located in the optical path. The etalon has a front dielectric reflective coating and a back dielectric reflective coating. In at least one etalon stage, the front reflective coating of the etalon has a wavelength-dependent reflectivity that varies according to location on the front face. The chromatic dispersion of the etalon is tunable according to a point of incidence of the optical path on the front reflective coating. The free spectral range may also be tunable. The cumulative chromatic dispersion of the chain of etalon stages substantially compensates for chromatic dispersion over an operating bandwidth within each of a plurality of wavelength channels.

The chromatic dispersion may vary from channel to channel. For example, the variation may be characterized by a dispersion slope which is substantially compensated for by the chain of etalon stages. In one implementation, the chain of etalon stages can be tuned to compensate for a range of dispersion slopes. In one variation, over the range of dispersion slopes, the chromatic dispersion of the chain of etalon stages is approximately constant at a reference wavelength. This system can be used to adjust dispersion slope while maintaining a constant dispersion offset at the reference wavelength. In another implementation, the chromatic dispersion of the chain of etalon stages is a substantially constant function of wavelength but can be tuned to compensate for a range of dispersion offsets. The two systems together can be used to tune both dispersion slope and dispersion offset.

In one embodiment, the channel spacing is consistent with the ITU grid as defined in ITU G.692 Annex A of COM 15-R 67-E). In some embodiments, the plurality of wavelength channels includes all wavelength channels from one of the following communications bands: the C-band (1528-1565 nm), the L-band (1565-1610 nm) and the S-band (1420-1510 nm).

In one implementation, the front coating has a wavelength-dependent reflectivity which varies according to a first coordinate x. The free spectral range varies according to a second orthogonal coordinate y. For example, the tunable free spectral range may be implemented by including a gradient index material as part of the body of the etalon, where the refractive index varies as a function of the coordinate y. Moving the point of incidence in the y direction tunes the free spectral range. In one implementation, a temperature controller coupled to the etalon controls temperature of the etalon and the phase of the optical path in the etalon can be tuned by varying the temperature.

Other aspects of the invention include methods corresponding to the devices and systems described above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram of a dispersion compensation system according to the invention.

FIG. 2 is a perspective view of a tunable etalon.

FIG. 3A is a graph of group delay as a function of wavelength for different values of reflectivity.

FIG. 3B is a graph of group delay as a function of wavelength illustrating the quasi-periodic nature of the group delay function.

FIGS. 4A-4B are graphs of reflectivity as a function of wavelength for different example coatings.

FIG. 5 is a graph illustrating the group delay of an example three-etalon dispersion compensation system.

FIGS. 6A-6B are graphs illustrating the reflectivity and phase of etalon front coatings.

FIGS. 7A-7D are graphs of reflectivity and phase shift as a function of wavelength for an example dispersion compensation system.

FIGS. 8A-8D are graphs illustrating dispersion compensation of the example system of FIG. 7.

FIGS. 9A-9B are side views of tunable etalons having a gradient index material and a top layer with continuously variable thickness.

FIG. 10 is a side view of a tunable etalon having a top layer with stepwise variable thickness.

FIGS. 11A-11C are side views of a tunable etalon illustrating one method for manufacturing the etalon.

FIG. 12 is a top view of an etalon stage in which an optical beam is translated relative to a stationary tunable etalon.

FIG. 13 is a top view of an etalon stage in which a tunable etalon is translated relative to a stationary optical beam.

FIGS. 14A-14B are a perspective view and top view of an etalon stage that utilizes a rotatable beam displacer.

FIGS. 15A-15B are top views of an etalon stage that utilizes a moveable reflective beam displacer.

FIG. 16 is a top view of an etalon stage that utilizes a MEMS beam displacer.

FIG. 17 is a top view of an etalon stage that utilizes separate input and output fibers.

FIG. 18 is a top view of an etalon stage that utilizes a free space circulator and a dual fiber collimator.

### DETAILED DESCRIPTION OF THE PREFERRED EMBODIMENTS

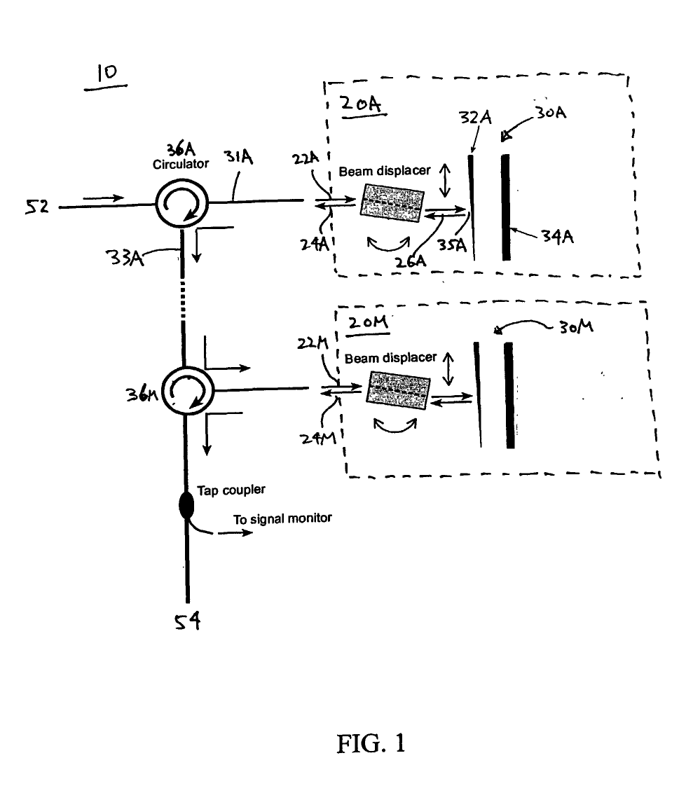

FIG. 1 is a block diagram of a dispersion compensation system 10 according to the invention. The system includes at least one etalon stage 20A-20M, preferably two or more. Each etalon stage 20 includes an input port 22, an output port 24 and an etalon 30. Within the etalon stage 20, light travels along an optical path 26 from the input port 22, through the etalon 30 to the output port 24.

The etalon stages 20 are cascaded to form a chain. In particular, the output port 24A of etalon stage 20A is coupled to the input port 22B of the next etalon stage 20B in the chain, and so on to the last etalon stage 20M. The input port 22A of the first etalon stage 20A serves as the input of the overall system 10 and the output port 24M of the last etalon stage 20M serves as the output of the overall system 10.

In the example of FIG. 1, the input ports 22 and output ports 24 are collocated. More specifically, incoming light arrives via fiber 31 and outgoing light exits via the same fiber 31, but propagating in the opposite direction. A circulator 36 is used to separate the incoming and outgoing beams. Thus, light propagates through the overall system 10 as follows. Light enters the system 10 at input 52 and is directed by circulator 36A via fiber 31A to etalon stage 20A. Within the etalon stage 20A, the light is incident upon etalon 30A at point 35A. Upon exiting etalon stage 20A, the light reenters fiber 31A to circulator 36A. Circulator 36A directs the light to fiber 33A and the next etalon stage 20B. The light propagates through the etalon stages 20 until it finally exits at output 54.

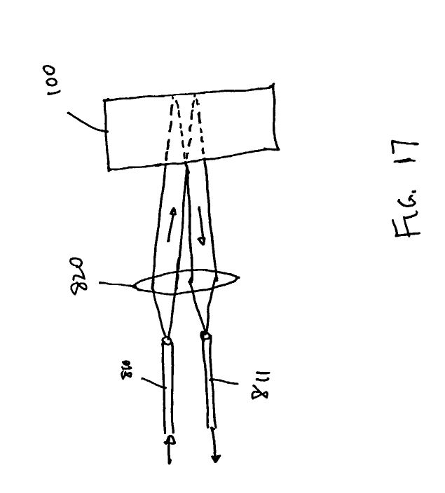

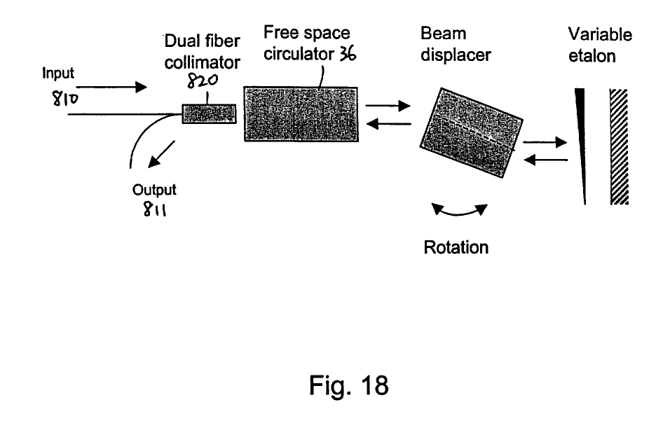

The etalon stages 20 can be coupled by devices other than a circulator 36. In cases where the input port 22 and output port 24 are collocated, different devices can be used to separate the incoming and outgoing beams. This general class of device shall be referred to as 3 dB couplers since they typically introduce an inherent 6 dB loss (3 dB on each pass through the device). Some examples of 3 dB couplers include waveguide couplers and fiber couplers. Circulators are an increasingly attractive alternative to 3 dB couplers since they typically introduce about 1.4 dB loss. In another embodiment, the input port 22 and output port 24 are physically separated. For example, the incoming beam may arrive on one fiber and the outgoing beam on a different fiber. See FIGS. 17 and 18 below for an example of this approach. In the examples of FIGS. 17 and 18, a dual fiber collimator is used to connect one etalon stage to the next and can have significantly less loss than a 3 dB coupler.

Each etalon 30 has a front dielectric reflective coating 32 and a back dielectric reflective coating 34. In at least one of the etalon stages 20, a point of incidence 35 of the optical path 26 on the front reflective coating 32 is tunable, meaning that the point of incidence 35 can be moved to different locations on the front reflective coating 32. The front reflective coating 32 of this particular etalon 30 has a reflectivity that varies according to location. At each location, the reflectivity also varies by wavelength. Thus, the effective wavelength-dependent reflectivity of the etalon 30 can be adjusted by adjusting the point of incidence 35. In addition, the free spectral range of the etalon 30 may also be tunable.

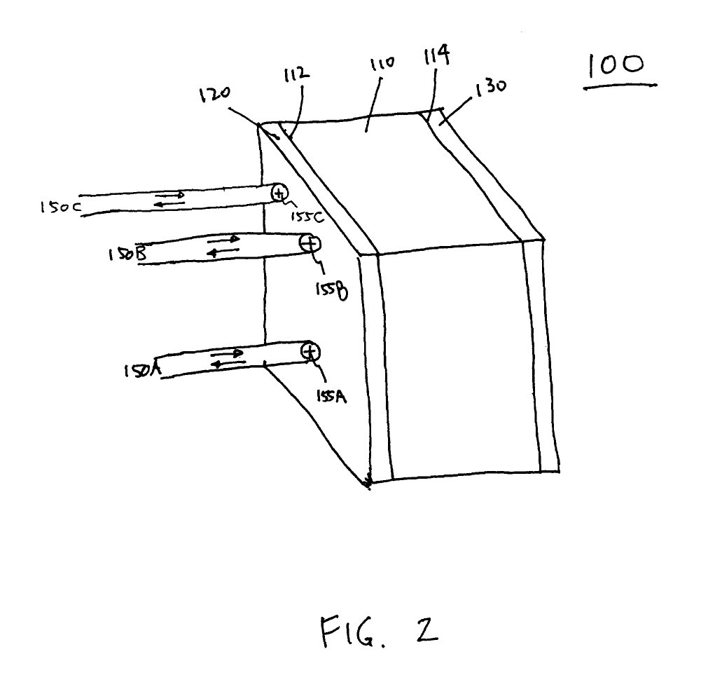

FIG. 2 is a perspective view of such a tunable etalon 100. The etalon 100 includes a transparent body 110 having a front surface 112 and a back surface 114. The front surface 112 and back surface 114 are substantially plane-parallel.

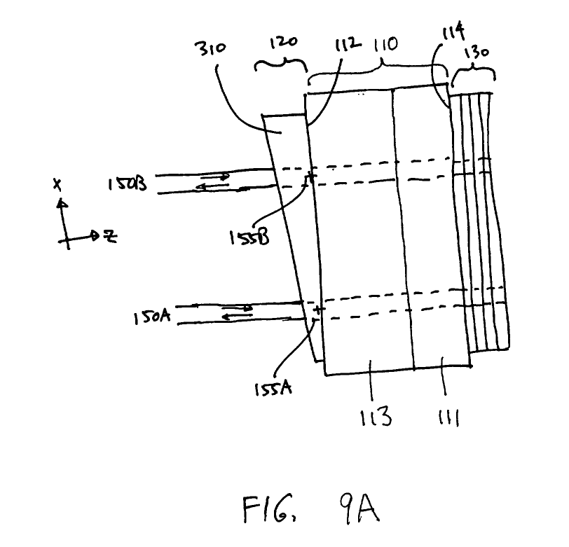

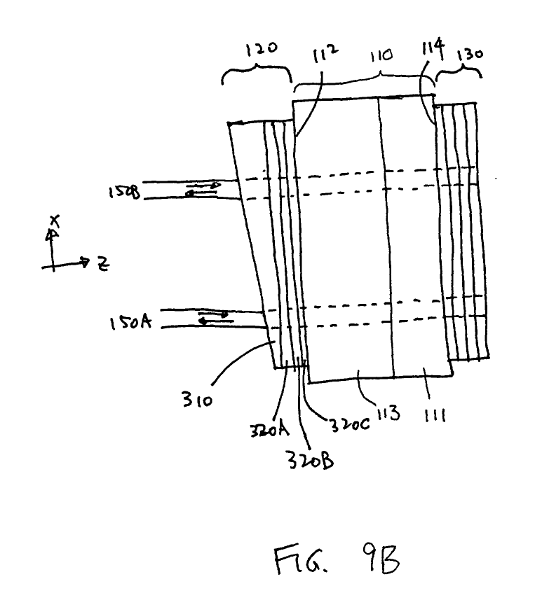

In one implementation, the transparent body 110 is made from a single block of material, as is suggested by FIG. 2. In another implementation, the transparent body 110 is made from blocks of different materials. For example, different materials may be bonded together to form a sandwich-type structure for the transparent body 110 (e.g., see FIG. 9). Alternately, some or all of the transparent body 110 may be formed by an air space or liquid crystals. In one implementation, in order from front surface 112 to back surface 114, the transparent body 110 consists of a first block of material, an air space, and a second block of material. The air space is maintained by spacers between the two blocks of material.

The front and back surfaces 112 and 114 are substantially plane-parallel in the sense that an optical beam 150 which is normally incident upon the front surface 112 also strikes the back surface 114 at an approximately normal angle of incidence. As will be seen in the examples below, it is not essential that the two surfaces 112 and 114 be exactly plane or exactly parallel. In typical cases, a parallelism of better than 0.5 arcsecond is sufficient although actual tolerances will vary by application. Furthermore, in certain cases, the optical path of a beam 150 through the etalon 100 may not be a straight line, For example, the optical beam 150 may be refracted through an angle at an internal interface in the etalon 100, or the optical path may be folded to form a more compact device by using mirrors, prisms or similar devices. In these cases, the front and back surfaces 112 and 114 may not be physically plane-parallel but they will still be optically plane-parallel. That is, the surfaces 112 and 114 would be physically plane-parallel if the optical path were unfolded into a straight line.

A back dielectric reflective coating 130 (labeled as back reflective coating 34 in FIG. 1) is disposed upon the back surface 114. The coating 130 has a reflectivity which is substantially 100%. A reflectivity somewhere in the range of 90-100% is typical, although the actual reflectivity will vary by application. If the reflectivity of back coating 130 is less than 100%, then light which is transmitted by the back coating 130 can be used to monitor the etalon 100. In applications where higher loss can be tolerated or the optical beam exits at least partially through the back surface 114, the reflectivity of back coating 130 can be significantly less than 100%. A front dielectric reflective coating 120 (labeled as coating 32 in FIG. 1) is disposed upon the front surface 112. The front reflective coating 120 has a reflectivity that varies according to location on the front surface 112.

With respect to reflectivity, the etalon 100 functions as follows. An optical beam 150 is incident upon the front surface 112 of the etalon 100 at a normal angle of incidence. The reflectivity of the etalon surfaces 112 and 114 results in multiple beams which interfere, thus producing etalon behavior. If the incoming optical beam is perfectly normal to the etalon's front surface 112 and the two surfaces 112 and 114 (and the coatings 120 and 130) are perfectly plane parallel, the output beam will exit the etalon 100 at the same location as the original point of incidence and will be collinear with the incoming beam 150 (but propagating in the opposite direction). The incoming and outgoing beams may be spatially separated at front surface 112 by introducing a slight tilt to the beam 150.

FIG. 2 shows two different positions for optical beam 150. In position A, the optical beam 150A strikes the front surface 112 at point of incidence 155A. In position B, the point of incidence is 155B. As will be shown below, different approaches can be used to tune the point of incidence to different locations on the etalon's front surface 112 while maintaining normal incidence of the optical beam. Typically, in a packaged stage, the optical beam 150 arrives via an input port, propagates into the etalon 100 and exits via an output port. In one class of approaches, the input port and/or the etalon 100 are moved in order to tune the point of incidence 155 to different locations. In another class of approaches, the input port and etalon 100 are fixed relative to each other, but a separate beam displacer tunes the point of incidence 155 of the optical beam on the etalon 100.

At the two different points of incidence 155A and 155B, the front reflective coating 120 has a different reflectivity and/or the reflectivity has a different wavelength dependence. Therefore, optical beam 150A is affected differently by etalon 100 than optical beam 150B. Different wavelengths within each beam 150 are also affected differently. In effect, the wavelength-dependent reflectivity of the etalon can be adjusted by varying the point of incidence 155.

The free spectral range of etalon 100 can also be adjusted. A number of different approaches can be used to implement this effect. The free spectral range depends on the optical path length of a round trip through the etalon. Thus, changing the optical path length changes the free spectral range.

In one class of approaches, the optical path length is changed while the point of incidence is held constant. For example, the optical path length of the etalon for optical beam 150B could be adjusted while the beam remained at point 155B. This can be achieved by varying the physical length of the etalon 100, for example by varying the length of an air space located in the body 110 of the etalon or by changing the spacing between the two reflective coatings 120 and 130. Alternately, the optical path length can be adjusted by varying the index of refraction within the etalon 100.

In another class of approaches, the free spectral range varies according to location and is tuned by tuning the point of incidence of the optical beam. For example, in the two examples of FIG. 9, the body 110 includes a gradient index material 111 bonded to a constant index material 113. In the 1.55 μm example described below, Gradium™, (available from LightPath Technology) or liquid crystal is suitable as the gradient index material 111 and fused silica, BK7 or similar glass can be used as the constant index material 113. The refractive index of the gradient index material 111 varies in they direction (i.e., perpendicular to the plane of the paper). Thus, the free spectral range of the etalon 100 can be tuned by moving the point of incidence in the y direction.

The dispersion D introduced by an etalon 100 can be calculated using conventional principles. In particular, the phase modulation ∅ introduced by etalon 100 is given by

$$φ = 2 {tan}^{- 1} ( \frac{r sin ω T}{1 + r cos ω T} ) \qquad ( 1 )$$

where r²=R is the reflectivity of the front coating 120 at the wavelength of interest, the back coating 130 is assumed to be 100% reflective, T is the round-trip delay induced by the etalon, and ω is the frequency of the optical beam 150. Specifically, T=OPL/c where c is the speed of light in vacuum and OPL is the total optical path length for one round trip through the etalon 100. If the one-way optical path through the etalon is a straight line of length L through material of refractive index n, then OPL=2nL. The group delay resulting from Eqn. (1) is

$$τ ( ω ) = - \frac{ⅆ φ ( ω )}{ⅆ ω} = - 2 r T r + \frac{cos ω T}{1 + {r}^{2} + 2 r cos ω T} \qquad ( 2 )$$

The dispersion D of the etalon is then

$$D ( λ ) = \frac{ⅆ τ ( λ )}{ⅆ λ} \qquad ( 3 )$$

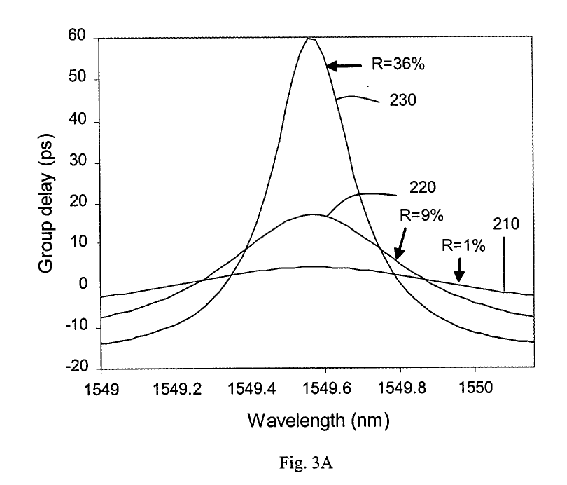

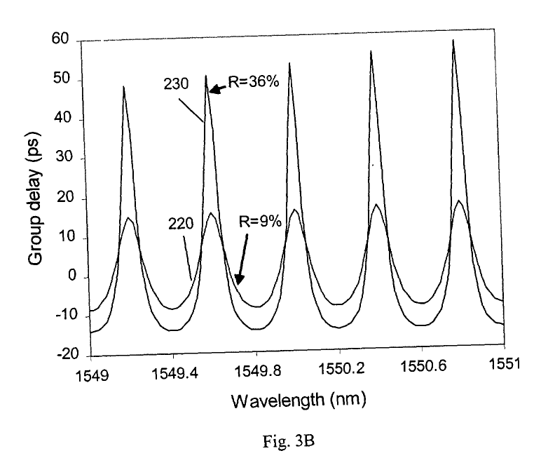

FIG. 3A is a graph of the group delay τ(γ) as a function of wavelength γ for three different values of the reflectivity R=r² where ω=2πc/γ0 where γ is the wavelength of the optical beam 150. The curves 210, 220 and 230 correspond to reflectivity values R of 1%, 9% and 36%. For simplicity, the optical path length OPL is assumed to be constant for these curves and the reflectivity is assumed to be constant with wavelength. The different values of R are realized by varying the point of incidence 155 of the optical beam 150. For example, the point of incidence 155A in FIG. 2 might have a reflectivity R of 1%, resulting in dispersion D corresponding to the group delay curve 210. Similarly, point 155B might correspond to curve 220 and some other point of incidence might correspond to curve 230. Therefore, the group delay and the dispersion experienced by the optical beam 150 as it propagates through etalon 100 can be varied by varying the point of incidence 155. Note that in this application, the front and back reflective coatings 120 and 130 cannot be metallic since metallic coatings result in unpredictable phase modulation and the dispersion D depends on the phase modulation φ.

Furthermore, if the reflectivity were independent of wavelength, the group delay τ(ω) and dispersion D would be periodic functions of the wavelength γ. The base period of these functions (i.e., the free spectral range of the etalon) is set by the optical path length OPL. When the reflectivity varies slowly with wavelength, the group delay τ(ω) is not exactly periodic but is still close to periodic (i.e., quasi-periodic). FIG. 3B is a graph of the quasi-periodic group delay over a broader range of wavelengths (as compared to the graphs in FIG. 3A) for an etalon with wavelength-dependent reflectivity. The spacing of the maximums in the group delay function is almost exactly equal to the free spectral range of the etalon. There may be a very slight variation due to the wavelength dependence. The magnitude of the maximum varies from one “period” to the next as a result of the wavelength dependent reflectivity. The location and spacing of the maxima (or minima) can be adjusted by changing the OPL. The location of the maxima and minima are sensitive to changes in the phase of the OPL. That is, phase changes in the OPL shifts the curves 220, 230 to the right or left without significantly affecting the base period of the curve.

The design and selection of materials for etalon 100 depends on the wavelength(s) γ of the optical beam 150, as well as considerations such as the end application, manufacturability, reliability and cost. Current fiber optic communications systems typically use wavelengths in either the 1.3 μm or 1.55 μm ranges and etalons intended for these systems would use corresponding materials. Obviously, the term “transparent body 110” means transparent at the wavelength of interest.

In one example, the etalon 100 is designed for use in the 1.55 μm wavelength range. The incoming optical beam 150 has a center wavelength (or multiple center wavelengths if the optical beam is wavelength division multiplexed) which is consistent with the ITU grid, as defined in the ITU standards.

The optical path length of body 110 is selected so that the free spectral range of the etalon 100 is matched to the basic periodicity of the ITU grid. For example, the ITU grid defines wave bands which are spaced at 100 GHz intervals. In one application, a fiber optic system implements one data channel per wave band (i.e., at a channel spacing of 100 GHz) and the free spectral range of the etalon 100 is also approximately 100 GHz, thus matching the ITU grid and the spacing of the wavelength channels. In another application, two data channels are implemented in each wave band. The spacing between channels is then 50 GHz, or half the band to band spacing on the ITU grid. The etalon 100 is designed to have a free spectral range of approximately 50 GHz, thus matching the channel spacing of the wavelength channels. The etalon can be designed to have a free spectral range that matches other periodicities, including those based on standards other than the ITU standards or those which are intentionally different than the ITU standards. For example, the etalon 100 may be intended for an application consistent with the ITU grid but the free spectral range of the etalon 100 may be different than the ITU periodicity in order to introduce variation in the etalon response from one band to the next.

The front and back surfaces 112 and 114 are plane-parallel to within 0.5 arc seconds and the back reflective coating 130 is a Bragg reflector with enough layers to achieve a reflectivity of over 99%, typically for this particular example. The front reflective coating 120 is a stack containing one or more layers of materials, as shown in the designs of FIGS. 9. The detailed structure of the layers determines the range of reflectivities achievable by the front reflective coating 120 and the wavelength dependence of the reflectivity, both of which depend on the application. The thickness varies in the x direction, so the reflectivity can be tuned by moving the point of incidence in the x direction.

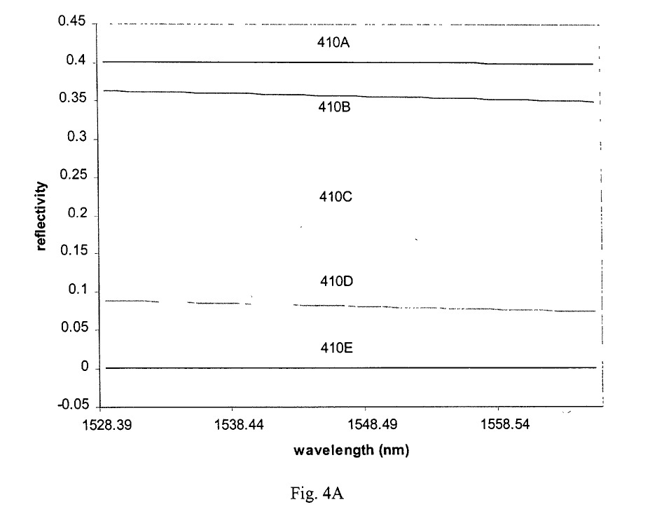

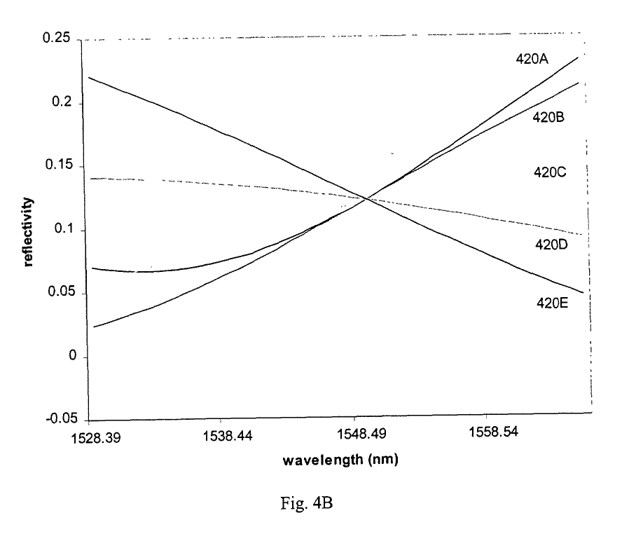

In one embodiment, the front reflective coating 120 has a relative flat response over the wavelength. Many coating structure are suitable for this coating desing. For example, the front coating can be a stack of three layers, following the design of FIG. 9 (although the specific example in FIG. 9 shows four layers). Working away from the etalon body, the first two layers are quarter wave layers of Y₂O_{3 and SiO}₂, respectively, having refractive indices of 1.75 and 1.44. The top layer is Ta₂O₅ with a refractive index of 2.07. The thickness of the top layer varies from zero to a quarter wave. The resulting reflectivity of the front reflective coating varies over a range from 0%-40%. The wavelength dependence of this coating is shown in FIG.4A. Curve 410A shows the reflectivity when the top layer thickness is a quarter wave thick. Curve 410E shows the reflectivity when the top layer thickness is zero. From curve 410E to curve 410A, the thickness of the top layer increases in uniform steps. Note that the reflectivity does not vary much with wavelength.

Other coating designs can also give a relatively flat response over the wavelength. Typically, by varying the thickness of top layer 310, a reflectivity variation of 40%-50% can be achieved. This variation can be translated to different offsets (e.g., to a range of 10%-60%, or 20%-70%, etc. for a variation of 50%) by varying the number and materials of the layers 320 under the top layer 310. Typically, in the design of FIG. 9, only the top layer 310 varies in thickness. The underlying layers 320 typically are not exposed. Many materials are suitable for front reflective coating 120, such as Ta₂O₅, TiO₂, SiO_{2, SiO, Pr}₂O₃, Y₂O₃, Al₂O₃, HFO₂ and AlF₃.

In another embodiment, the reflectivity of the front reflective coating 120 varies significantly with wavelength. Many coating designs can achieve a desired wavelength dependency by using non-quarter wave thicknesses. In one example, the front coating includes five layers of material. Working away from the etalon body, the layers are (1.779 TiO₂, 1.514 Al₂O₃, 1.115 TiO₂, 0.131 SiO₂, and 0.221 HFO₂). The number in front of the material name is the optical path length of that layer, which is the product of refractive index and thickness of each layer. The optical path length is measured in units of a reference wavelength. The top layer is HFO₂. Its thickness varies at different locations. FIG. 4B shows the reflectivity of this coating as a function of wavelength. Different curves in FIG. 4B correspond to different thicknesses of the top layer. From curve 420E to curve 420A, the top layer thickness changes from 0 to 0.113 μm. One characteristic of this coating is that the slope of the reflectivity curves 420 change with varying thickness for the top layer, but the reflectivity at the center wavelength remains relatively constant. This characteristic will be used to achieve tunable slope compensation.

Referring to FIG. 1, each etalon stage 20 introduces a certain group delay τ(ω) and corresponding dispersion D(γ). These quantities are additive. The cumulative group delay produced by all of the stages 20 is the sum of the group delays produced by each etalon stage 20. Similarly, the cumulative dispersion produced by all of the stages 20 is the sum of the dispersions produced by each etalon stage 20. By appropriately selecting the group delay introduced by each stage 20, a substantially linear group delay curve (or a substantially constant dispersion) can be achieved for the overall system over a certain operating bandwidth.

Furthermore, if the free spectral ranges of all the etalon stages are approximately equal, then the group delay curve will also be approximately periodic. Thus, the overall system can be used to substantially compensate for chromatic dispersion over an operating bandwidth within each of a multiplicity of wavelength channels. For example, the wavelength channels may be spaced by 100 GHz and the overall system may substantially compensate for chromatic dispersion over an operating bandwidth of 60 GHz within each wavelength channel for a certain number of channels. For some applications, it is preferable that the overall system be able to compensate for chromatic dispersion over all wavelength channels within a communications band, for example the C-band (1528-1565 nm), the L-band (1565-1610 nm) or the S-band (1420-1510 nm).

In many fibers, the chromatic dispersion also varies from channel to channel. For example, the chromatic dispersion may be characterized by a dispersion slope. As will be shown below, by correct selection of the reflectivities and free spectral ranges, enough aperiodicity can be introduced into the overall system to compensate for the dispersion slope (or other channel to channel variations in the chromatic dispersion).

More specifically, suppose that there are a total of m etalon stages, as shown in FIG. 1. Let ω=2πc/γ=2πf, where γ is the wavelength in vacuum and f is the frequency. Each individual stage i is characterized by a reflective coefficient rᵢ and round-trip delay Tᵢ=2 (nᵢ Lᵢ+δᵢ)/c, where nᵢ and Lᵢ are the refractive index and nominal physical length of the body of the etalon (actually, the summation of product nL for all materials in the body) and δᵢ is a variable phase tuning factor. Eqn. (2) can be expressed for the i-th stage as

$${τ}_{i} ( λ ) = - ( \frac{4 {r}_{i} ( {n}_{i} {L}_{i} + {δ}_{i} )}{c} ) {r}_{i} + \frac{cos ( \frac{4 π ( {n}_{i} {L}_{i} + {δ}_{i} )}{λ} )}{1 + {r}_{i}^{2} + 2 {r}_{i} cos ( \frac{4 π ( {n}_{i} {L}_{i} + {δ}_{i} )}{λ} )} , \\ i = 1 , 2 , … m \qquad ( 4 )$$

As shown in Eqn. (4), the group delay τᵢ is affected by both the reflective coefficient rᵢ and the optical path length (nᵢLᵢ+δᵢ). It is possible to obtain a quasi-linear group delay by superimposing multiple group delay curves with proper phase matching conditions. To illustrate the concept of employing multiple stages to achieve a tunable quasi-linear group delay, the following example uses a three-stage configuration following the architecture in FIG. 1 (with M=m=3). The same idea can be extended to more or fewer stages in a straightforward manner. Increasing the number of stages reduces group delay ripple but at a cost of higher insertion loss and higher material cost. With enough stages, operating bandwidths which exceed 50% of the free spectral range of the etalons are possible.

The total group delay τ_{T}(γ) for an m-stage configuration can be expressed as

$${τ}_{T} ( λ ) = {\sum }_{i = 1}^{m} {τ}_{i} ( λ ) \qquad ( 5 )$$

Hence, the dispersion D of the multi-stage system is related to the total group delay τ_{T}(γ) by

$$D ( λ ) = \frac{ⅆ {τ}_{T} ( λ )}{ⅆ λ} \qquad ( 6 )$$

Generally, better performance can be achieved by adding more degrees of freedom. Better performance typically means larger dispersion tuning range, less residual dispersion and/or ripple (i.e., better dispersion compensation) and/or a wider operating bandwidth. More degrees of freedom typically means more stages 20, more variability in the reflectivity R and/or more variability in the optical path length OPL (which is typically implemented as more variability in the free spectral range and/or more variability in the tuning factor δ). Furthermore, with enough variability, a system 10 can be tuned to compensate for different amounts of chromatic dispersion within a wavelength channel and/or different amounts and types of channel to channel variation in the chromatic dispersion.

The tunability can also compensate for manufacturing variability. For example, consider a situation in which the target reflectivity for a stage is 15%±0.01%. One approach would be to manufacture a constant-reflectivity etalon with a reflectivity of between 14.99 and 15.01%. An alternate approach would be to manufacture a variable reflectivity etalon which is tunable to 15% reflectivity. For example, if the etalon nominally could be tuned over a range of 1%-40%, then even a manufacturing tolerance of±1% (as opposed to±0.01%) would result in an etalon which could reach the required 15% reflectivity.

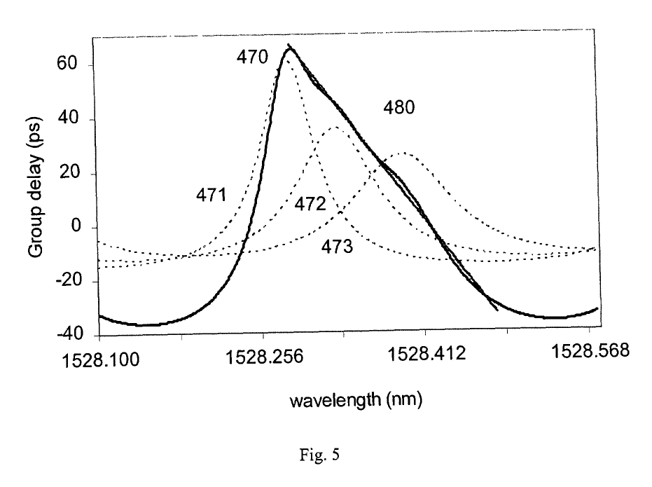

FIG. 5 illustates the group delay curve of an example system 10 which consists of three etalon stages 20, as described previously in FIG. 4A. The curves 471-473 shown by dashed lines are the group delay curves of each of the three etalons. The curve 470 shows group delay curve of the whole system. It is the summation of curve 471-473. The curve 480 is a best fit line to curve 470 over the operating bandwidth of the channel. The difference between curve 470 and curve 480 is called group delay ripple, which preferably is minimized.

FIG. 5 only shows the group delay at a single channel. Most fiber has different dispersion at different channels. The dispersion of the optical fiber can be approximated by a linear function

D(γ)=D₀+α(γ−γ₀) (7)

where γ₀ is the reference wavelength, D₀ is the dispersion at the reference wavelength, and α is the dispersion slope.

In one implementation, FSR mismatch is used to compensate for this dispersion slope. In other words, the FSR of the etalon is chosen to be slightly different from the channel spacing of the ITU grid. For example, if the channel spacing is 50 GHz, the FSR of the etalon might be chosen to be somewhere from 49.97 GHz-50.03 GHz, in order to compensate for dispersion slope values. Although etalons with FSR mismatch can compensate for different dispersions at different channels, the performance typically cannot be optimized for all channels simultaneously. Some channels may still suffer large group delay ripple that degrades the optical signal quality.

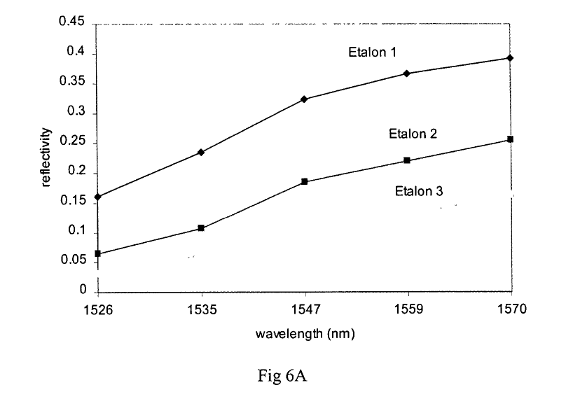

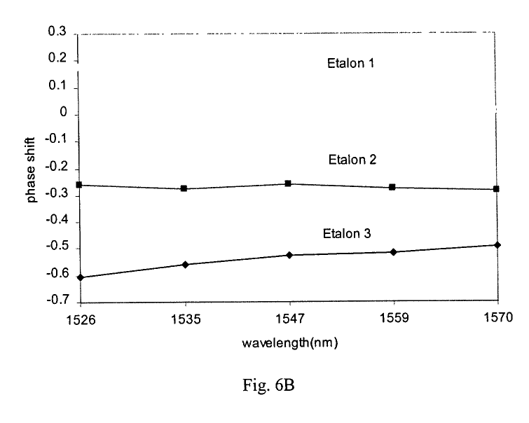

Referring to Eqn. 4, the group delay of system 10 is determined by the reflectivity and phase shift of each etalon. In order to improve the overall system performance, the reflectivity and phase shift of each individual etalon can be selected so as to improve the performance at each channel of interest. For example, if the system is to be used in the C-band, the performance can be optimized at each relevant wavelength in the C-band. FIGS. 6A-6B show these etalon parameters for a system which compensates for chromatic dispersion introduced by

100 km of E-LEAF fiber. FIG. 6A shows the reflectivity of the front coating. FIG. 6B shows the phase shift of each etalon. Both of these parameters are a fuction of wavelength. The etalon parameters for this design are obtained using standard optimization techniques reduce the group delay ripple for each channel. Other designs can be obtained by using similar techniques.

The front relective coatings of the etalons are designed to match the reflectivity curves shown in FIG. 6A. The FSRs of the etalons are tuned to achieve the desired phase shift shown in FIG. 6B. In one implementation, the basic setup is the one shown in FIG. 2. The wavelength-dependent reflectivity curve varies in the vertical direction but the free spectral range varies in the orthogonal, horizontal direction. Thus, tuning the point of incidence from 155B to 155C maintains the same reflectivity curve but adjusts the free spectral range. Conversely, tuning the point of incidence from 155B to 155A maintains the same free spectral range but adjusts the reflectivity. The etalon can also be designed so that the free spectral range and reflectivity vary in a coupled fashion.

Comparing FIG. 6B with FIG. 6A, the phase shift variation over wavelength is seen to be not as significant as the reflectivity variation over wavelength. Therefore, for some applications, a constant phase shift is acceptable and only the reflectivity varies with wavelength in order to compensate for dispersion slope. This simplies the design and manufacture of the system.

The reflectivity curves shown in FIG. 6A are realized by proper design of the front reflective coating. Multiple solutions exist for the same reflectivity curve. In one solution, the system 10 shown in FIG. 1 consisits of three etalons. The etalon material is BK7 glass. The front coating of each etalon consists of five layers of material. The recipe of each etalon's front coating is as follows:

etalon 1, (1.330 TiO₂, 1.297 SiO₂, 1.512 TiO₂, 0.101 SiO₂, 0.139 Ta₂O₅).

etalon 2, (1.808 Ta₂O₅, 1.371 SiO₂, 0.981 Ta₂O₅, 0.105 SiO₂, 0.126 Ta₂O₅).

etalon 3, (1.781 Ta₂O₅, 1.602 Al₂O₃, 1.131 TiO₂, 0.131 SiO₂, 0.221 Ta₂O₅).

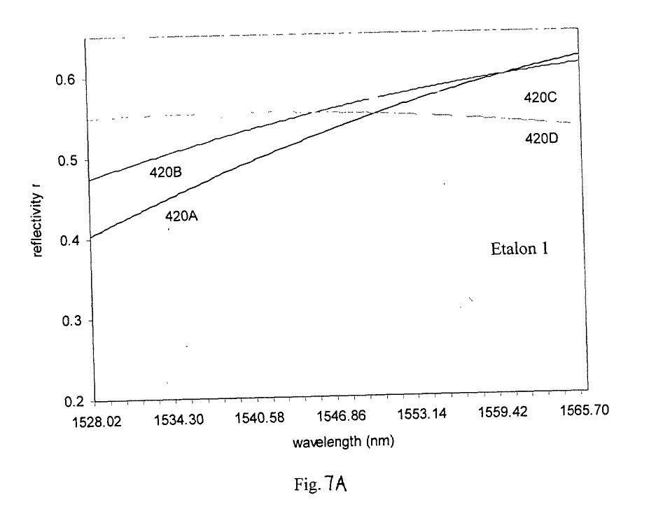

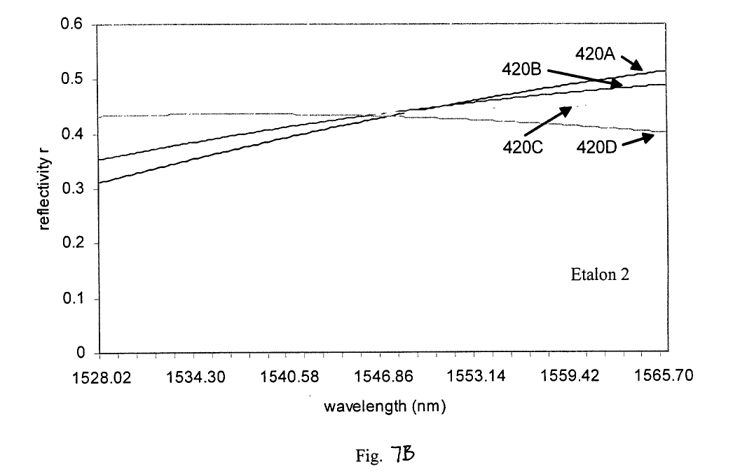

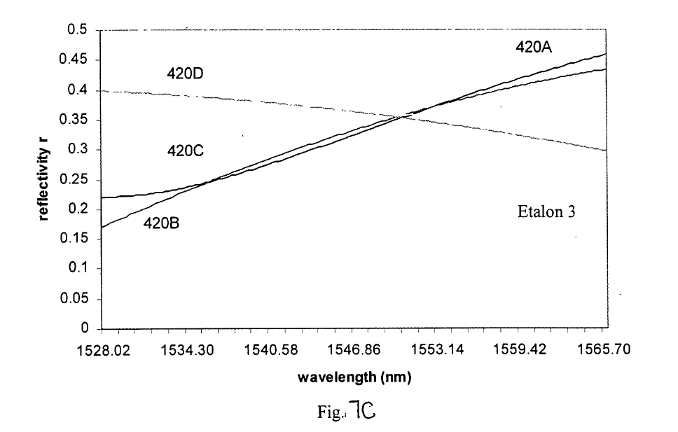

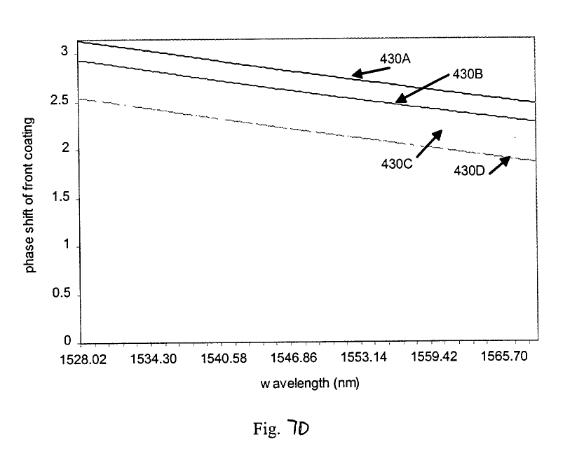

FIGS. 7A-7C show the reflective coefficient r as a function of wavelength for these coatings. FIGS. 7A-7C are the reflectivity of etalon 1, etalon 2, and etalon 3, respectively. Different curves in each chart correspond to the reflectivity at different thicknesses of the top layer. Curves 420A-420D correspond to thicknesses of 0%, 25%, 50% and 75% of the total thickness of the top coating layer. The thickness of the other coating layers is choosen to achieve the desired reflectivity slope, which in turn compensates for dispersion slope.

The reflectivity of the each etalon can be tuned by changing the point of incidence on the etalon. When the reflectivity is tuned, the slope of the reflectivity curve changes but the reflectivity value at the reference wavelength remains approximately constant, as shown in FIGS. 7A-7C. This is a useful characteristic for achieving tunable dispersion slope compensation, as it allows the dispersion slope to be tuned without introducing a significant dispersion offset. The reference wavelength is approximately 1550 nm which, in this example, may not be at the center of the wavelength bands.

The coating design shown in this example also produces a phase shift response. FIG. 7D shows the phase shift caused by the front coating of etalon 2. The other etalons have similar curves. The different curves 430A-430D correspond to different thicknesses of the top coating layer and correspond to the curves 420A-420D in FIGS. 7A-7C. Three effects can be observed in FIG. 7D. First, the phase shift is a linear function of wavelength. The linear phase shift can be compensated by FSR mismatch. Second, when the reflectivity slope is tuned (i.e., the point of incidence is tuned), the curve shifts up or down. This shift can be compensated by temperature tuning. Third, the slope of the phase shift curve does not change significantly when the reflectivity slope is tuned. Therefore, for many applications, there is no need to tune the FSR when the dispersion slope-is tuned. This simplifies the device.

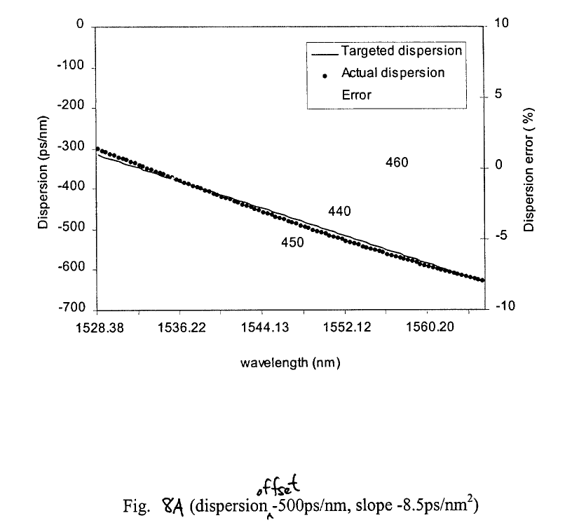

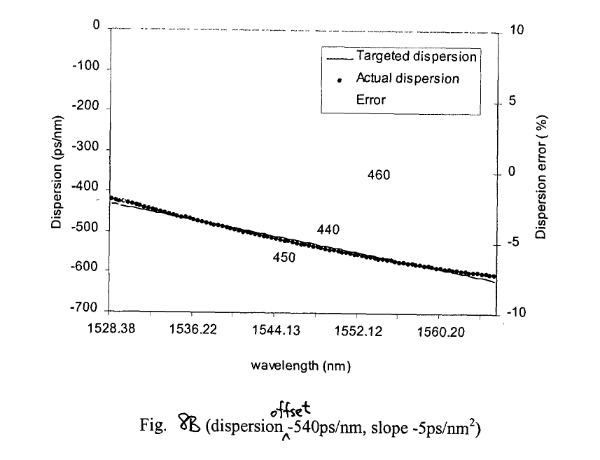

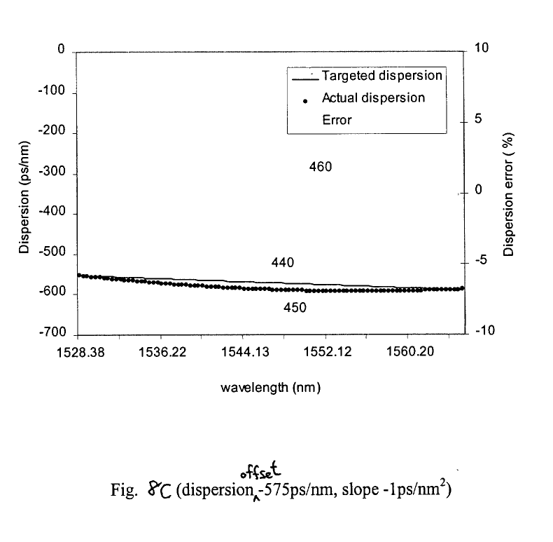

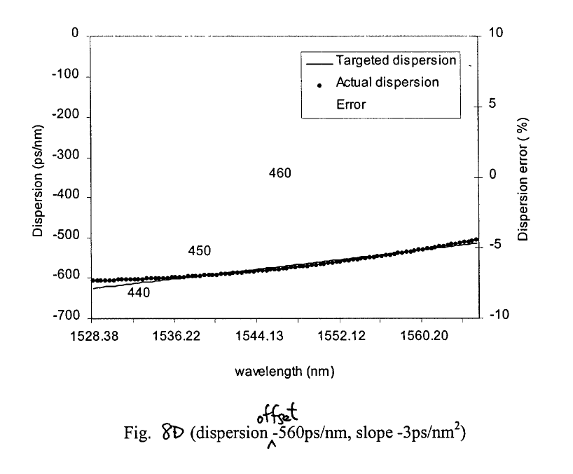

FIGS. 8A-8D shows the dispersion as a function of wavelength of this system. Curve 450 is the actual chromatic dispersion realized by the three-etalon system. Note that curve 450 is not a continuous curve. Each dot on curve 450 represents the chromatic dispersion value of the three-etalon system within the operating bandwidth for one of the wavelength channels. The complete set of dots represents the chromatic dispersion values for all of the wavelength channels. Curve 460 is the absolute error in the actual chromatic dispersion 450, as measured as a percentage of the ideal chromatic dispersion 440. This curve 460 has the same form as curve 450. The dots represent actual errors for each wavelength channel.

The dispersion slope of the system, using the coating designs discussed above, can be continuely tuned from 4 ps/nm² to −8.5 ps/nm². FIG. 8A illustrates a dispersion slope of −8.5 ps/nm², which compensates for 100 km of LEAF fiber. Other dispersion slopes can be achieved by changing the point of incidence on each etalon. FIG. 8B shows a dispersion slope of −5 ps/nm² with a slight dispersion offset to −540 ps/nm at the reference wavelength. FIG. 8C has a dispersion slope of −1 ps/nm² and a dispersion of −575 ps/nm at the reference wavelength. The small dispersion deviation at the reference wavelength can be minimized by increasing the number of layers in the front reflective coating or by introducing a tunable dispersion offset to compensate. FIG. 8D shows an example with a positive dispersion slope of 3 ps/nm².

The three-etalon example discussed above is one possible solution among many. Other solutions which use different materials, different numbers of layers in the coating, and different thicknesses for the layers can also be used to tune dispersion slope without introducing a significant dispersion offset. Systems can also be designed to target a specific type of fiber. For example, the system can be designed so that the dispersion offset value and dispersion slope value are closely matched to the values required to compensate for a specific fiber of certain length. In other words, the dispersion offset and dispersion slope both change as the sytem is tuned.

In order to realize a specific chromatic dispersion slope curve over a plurality of wavelength channels, the system is tuned to specific values of reflective coefficient r, free spectral range and/or OPL tuning factor γ. These target values can be determined for different dispersion curves using standard optimization techniques. To a first order, the optimization problem can be described as, for a given set of wavelength channels, operating bandwidths within each channel and target dispersion curve D(γ), find the set of parameters (rᵢ, δᵢ) which minimizes some error metric between the actual dispersion realized and the target dispersion or, equivalently, between the actual group delay realized and the target group delay. For dispersion that is approximately constant within each wavelength channel but increases or decreases across wavelength channels, the target group delay will be a linear function of wavelength within each channel with the slope of the linear function increasing or decreasing with wavelength. Examples of error metrics include the peak-to-peak deviation, maximum deviation, mean squared deviation, and root mean squared deviation. Examples of optimization techniques include the multidimensional downhill simplex method and exhaustive search. Exhaustive search is feasible since the degrees of freedom (rᵢ, δᵢ) typically have a limited range.

There can be multiple solutions for a given dispersion curve and factors in addition to the error metric typically are used to select a solution. For example, one such factor is the sensitivity of the solution to fluctuations in the parameters. Less sensitive solutions are usually preferred. Another factor is the manufacturability or practicality of the solution.

The solutions (rᵢ, δᵢ) for different dispersion curves and/or operating bandwidths typically are calculated in advance. They can then be stored and recalled when required. In one embodiment, system 10 includes a lookup table that tabulates the parameters (rᵢ, δᵢ) as a function of dispersion curve and/or bandwidth. When a specific dispersion compensation is required, the corresponding parameters (rᵢ, δᵢ) are retrieved from the lookup table and the stages are tuned accordingly.

In order to tune the stages, a conversion from the parameters (rᵢ, δᵢ) to some other parameter is typically required. In the example three-stage system described above, the reflective coefficient r is converted to a corresponding x coordinate and OPL tuning factor δ to a corresponding temperature. There are many ways to achieve this. In one approach, each stage is calibrated and the calibration is then used to convert between (r, δ) and (x, T).

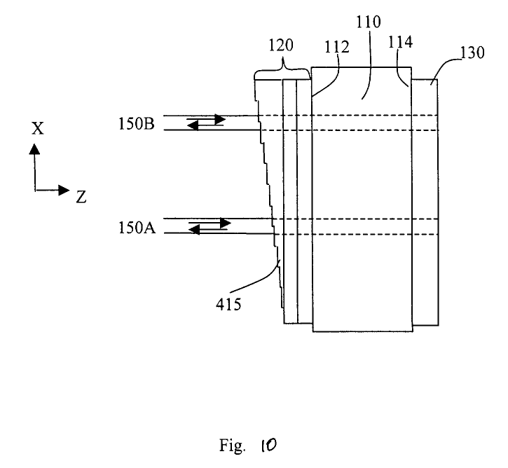

In addition to FIGS. 9, FIGS. 10-11 also illustrate various manners in which the reflectivity can vary over the front surface 112 of a tunable etalon. In the examples of FIGS. 9, the reflectivity was a continuous function of location on the front surface. The thickness of top layer 310 varied continuously with the linear coordinate x. In FIG. 10, the front reflective coating 120 includes a top layer 415 of material that varies in physical thickness in a stepwise fashion. That is, layer 415 has a constant thickness over some finite region, a different constant thickness over a second region, etc. In FIG. 10, these regions are rectangular in shape, with a finite extent in x but running the length of the etalon in y. However, they can be other shapes. For example, hexagonally-shaped regions are well matched in shape to circular beams and can be close packed to yield many different regions over a finite area.

Other variations of thickness as a function of position are possible. In this class of variable reflectivity etalons, the reflectivity of front reflective coating 120 is generally determined by the thickness of the coating (or of specific layers within the coating). Therefore, different reflectivity functions may be realized by implementing the corresponding thickness function. For example, reflectivity can be made a linear function of coordinate x by implementing the corresponding thickness variation in the x direction. The required thickness at each coordinate x can be determined since the relationship between thickness and reflectivity is known, for example by using conventional thin film design tools. The reflectivity and/or thickness can also vary according to other coordinates, including y, the polar coordinates r and/or θ, or as a two-dimensional function of coordinates.

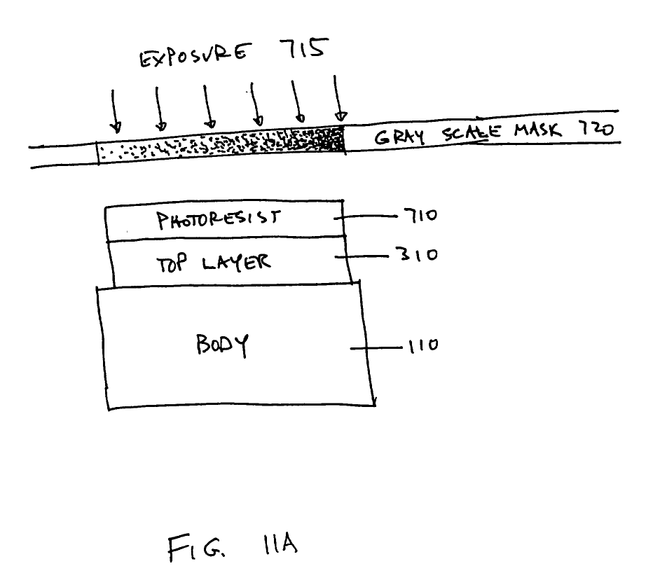

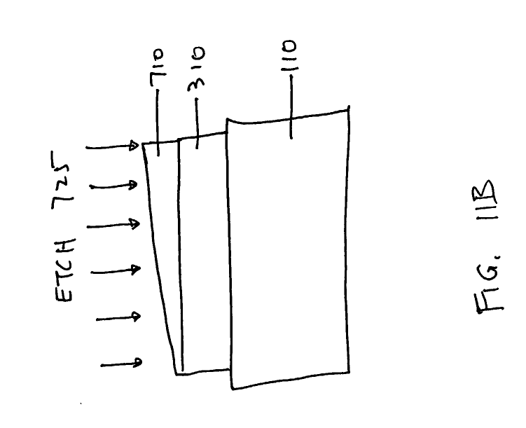

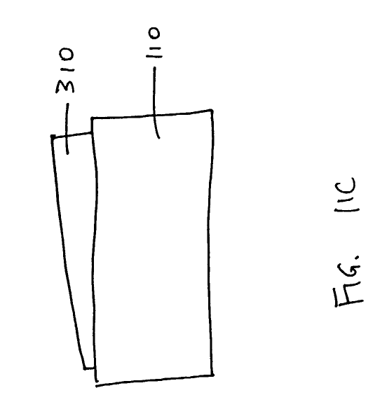

FIGS. 11A-11C illustrate one method for manufacturing the etalon shown in FIG. 9. Basically, a top layer 310 of uniform thickness is first deposited on the front surface 112 of the etalon body 110. Then, different thicknesses of the top layer 310 are removed according to the location on the front surface. What remains is a top layer 310 of varying thickness.

In FIG. 11A, a uniform top layer 310 has already been deposited on the etalon body 110 using conventional techniques. The top layer 310 has also been coated with photoresist 710. The photoresist 710 is exposed 715 using a gray scale mask 720. Thus, the photoresist receives a variable exposure. In FIG. 11B, the photoresist 710 has been developed. The gray scale exposure results in a photoresist layer 710 of variable thickness. The device is then exposed to a reactive ion etch (RIE). In areas where there is thick photoresist, the etch removes all of the photoresist and a little of the top layer 310 of the front reflective coating. In areas where there is thin photoresist, the etch removes more of the top layer 310. The end result, shown in FIG. 11C is a top layer of varying thickness.

FIGS. 11A-11C illustrate a manufacturing process that uses reactive ion etching although other techniques can be used. For example, in a different approach, other uniform etching techniques or ion milling can be used to remove different thicknesses from the top layer 310. Mechanical polishing techniques or laser ablation may also be used. In one laser ablation approach, a laser is scanned across the top layer 310 and ablates different amounts of material at different locations. The result is a top layer 310 of varying thickness. In a different approach, rather than depositing a top layer 310 of uniform thickness and then removing different amounts of the top layer, a top layer 310 of varying thickness is deposited. Finally, FIGS. 11A-11C describe the manufacture of the etalon in FIG. 9A. However, the techniques described can be used to manufacture other types of tunable etalons, including those shown in FIGS. 9-10.

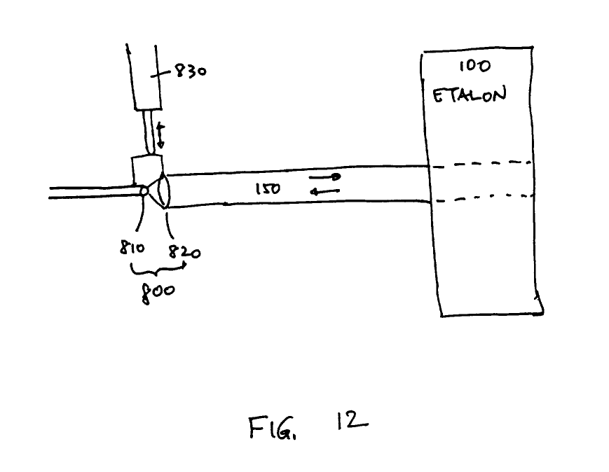

FIGS. 12-16 illustrate different ways to translate the point of incidence of the optical beam 150. In all of these examples, the incoming optical signal is shown as arriving via an optical fiber 810 and collimated by a lens 820 to produce the optical beam 150. This is merely a pictorial representation of the input port 800 (labeled as input port 22 in FIG. 1) for optical beam 150. It is not meant to imply that other designs for the input/output ports cannot be used. For example, the optical beam 150 may arrive in a collimated form, the lens may be integrated onto the fiber, the fiber may be replaced by a waveguide, there may be other intermediate devices (e.g., mirrors, beamsplitters, optical filters), etc. Note that the input port 800 can also serve as the output port. In FIGS. 12-16, the optical signal is shown as arriving via fiber 810, collimated by lens 820, propagates through etalon 100, is re-collected by lens 820 and exits via fiber 810.

FIG. 17 is a top view of an etalon stage that uses separate input and output fibers 810 and 811. In this device, the two fibers 810 and 811 are placed symmetrically about the optical axis of the collimating lens 820. Thus, the optical beam 150 will leave fiber 810, reflect through the etalon 100 and return to fiber 811. The optical beam 150 will not be exactly normally incident on the etalon 100. However, some deviation from normal incidence can be tolerated without significantly affecting the overall performance. A typical tolerance is that the beam is within 0.6° of normal to prevent significant effects due to beam walk off, although actual tolerances will depend on the application. The beam displacement approaches described in FIGS. 12-16 below are also generally applicable to the architecture shown in FIG. 17. One advantage of the dual fiber approach is that a circulator (or other similar device) is no longer required to separate the incoming and outgoing beams.

FIG. 18 is a top view of an etalon stage that utilizes a dual fiber collimator 820 and a free space circulator 36. In this device, two fibers 810 and 811 are coupled to a dual fiber collimator 820 which is coupled to the rest of the etalon stage by a free space circulator 36. Thus, an optical beam is input via fiber 810, is collimated by the dual fiber collimator 820 and then enters the remainder of the etalon stage. On the return trip, the optical beam enters the circulator 36 from the opposite direction and, as a result, is directed to output fiber 811 rather than input fiber 810. As with FIG. 17, the beam displacement approaches described in FIGS. 12-16 below are also generally applicable to the architecture shown in FIG. 18. Advantages of this approach include reduced size and lower optical loss.

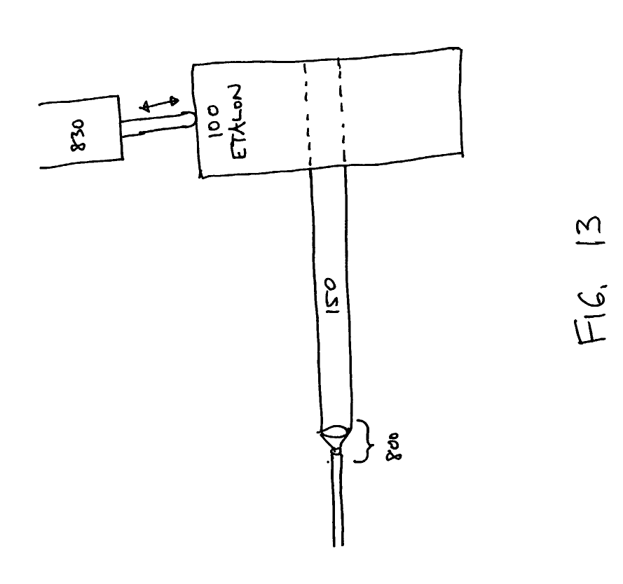

In FIGS. 12-13, beam displacement is achieved by creating relative movement between the input port 800 and the tunable etalon 100. In FIG. 12, the input port 800 is translated relative to a stationary tunable etalon 100. In particular, a mechanical actuator 830 moves the fiber 810 and collimating lens 820, thus moving the point of incidence. More generally, an actuator which is physically connected to the input port 800 can be used to translate the input port 800 relative to the etalon 100, thus changing the point of incidence. In FIG. 13, a mechanical actuator 830 is connected to the etalon 100 and translates the tunable etalon 100 relative to a stationary optical beam 150. In other implementations, both the input port 800 and the etalon 100 can be moved simultaneously.

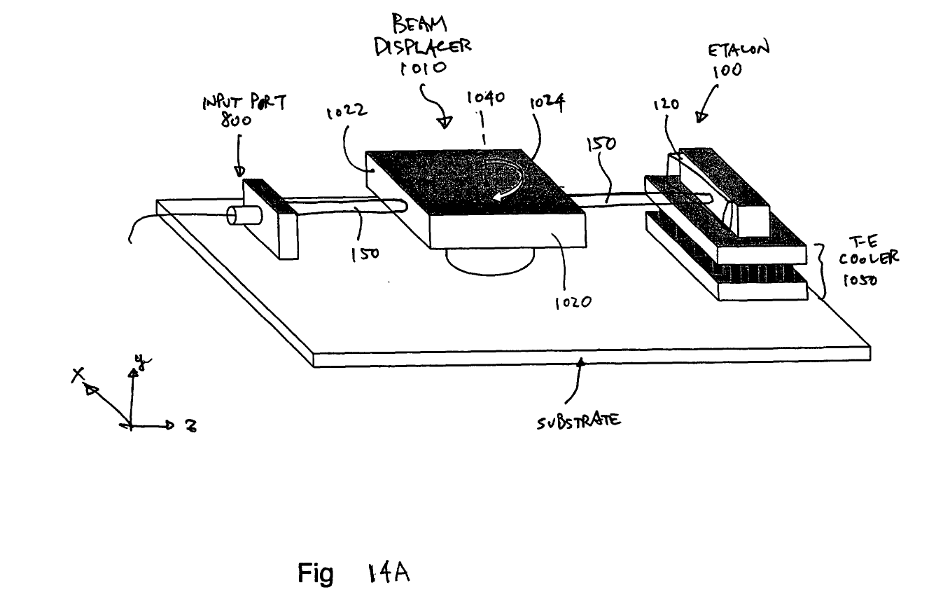

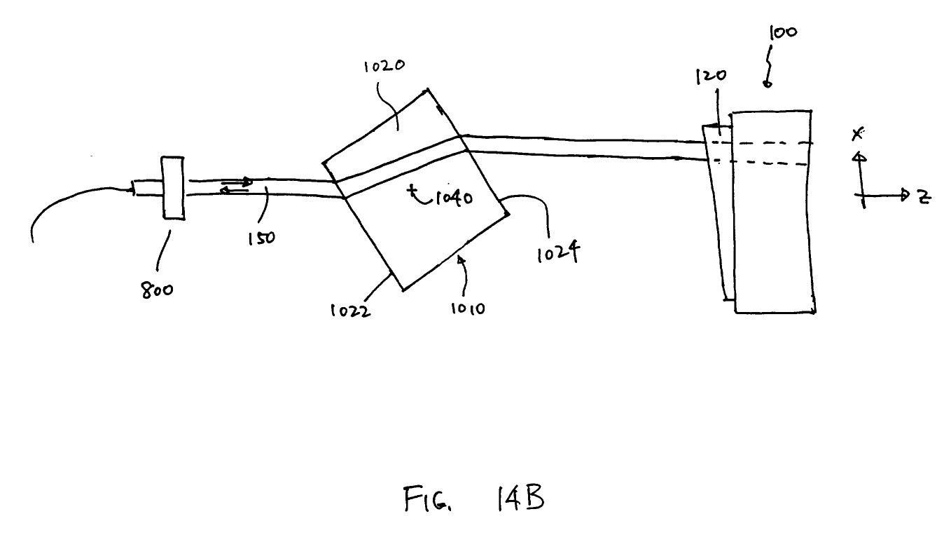

In FIGS. 14-16, the input port 800 and etalon 100 remain in fixed locations relative to each other. A separate beam displacer 1010, 1110, 1210 is located in the optical path between the input port 800 and etalon 100. The beam displacer is used to change the point of incidence of the optical beam 150 to different locations on the etalon's front surface while maintaining normal incidence of the optical beam on the etalon's front surface.

FIGS. 14A-14B are a perspective view and a top view of an etalon stage in which the beam displacer 1010 is rotated in order to change the point of incidence. In this example, the beam displacer 1010 includes a transparent body 1020 that has an input surface 1022 and an output surface 1024. The beam displacer 1010 is located in the optical path of the optical beam 150 and rotates about an axis 1040 which is perpendicular to the direction of propagation of the optical beam 150. In this example, the input and output surfaces 1022 and 1024 are plane-parallel to each other. In FIGS. 14, the optical beam 150 propagates in the z direction, the reflectivity of etalon 100 varies in the x direction, and the axis of rotation 1040 is in the y direction.

The beam displacer 1010 operates as follows. The optical beam 150 enters the transparent body 1020 through the input surface 1022 and exits the body 1020 through the output surface 1024. Since the two surfaces 1022 and 1024 are parallel to each other, the exiting beam propagates in the same direction as the incoming beam, regardless of the rotation of the beam displacer 1010. As a result, the exiting beam always propagates in the z direction and the etalon 100 is oriented so that the beam 150 is normally incident upon it. Rotation of the beam displacer 1010 about they axis produces a translation of the optical beam in the x direction due to refraction at the two surfaces 1022 and 1024. The reflectivity of the front reflective coating 120 also varies in the x direction. Thus, different reflectivities for etalon 100 can be realized by rotating the beam displacer 1010.

FIGS. 14 also show the etalon 100 as being mounted on a thermoelectric cooler 1050. The cooler 1050 is in thermal contact with the transparent body of the etalon 100 and is used to control the temperature of the etalon since the temperature affects the free spectral range and OPL tuning factor of the etalon. Other types of temperature controllers may be used in place of the thermoelectric cooler 1050.

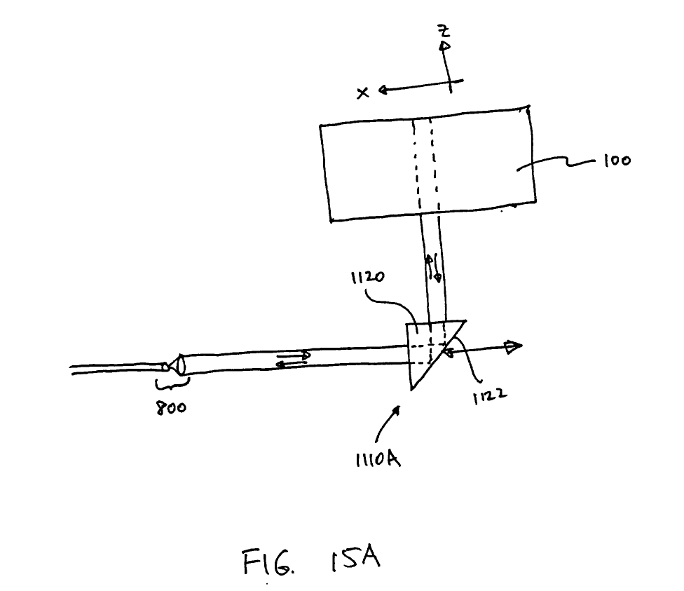

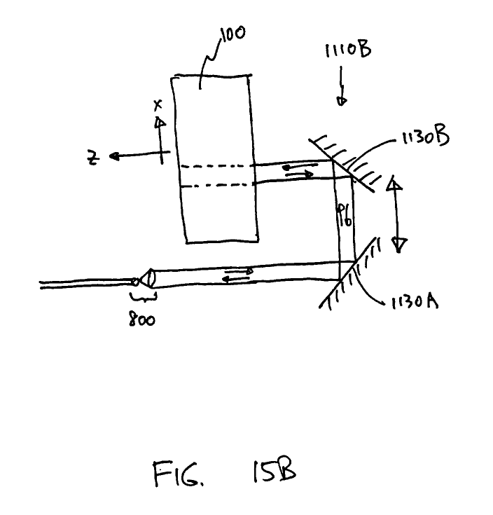

In FIGS. 15A-15B, the beam displacers 1110A and 1110B are based on translatable reflective surfaces. Generally speaking, the optical beam 150 reflects off of at least one reflective surface en route to the etalon 100. By translating the reflective surface, the point of incidence for the optical beam 150 is moved but the normal incidence is maintained. In FIG. 15A, the beam displacer 1110A includes a right angle prism 1120 and the reflective surface is the hypotenuse 1122 of the prism. The optical beam 150 enters the prism, total internally reflects off the hypotenuse 1122 and exits the prism to the etalon 100. By translating the prism 1120, the point of incidence on the etalon can be moved. Note that the prism can be translated in many directions. For example, translating in either the x or z direction will result in movement of the point of incidence.

In FIG. 15B, the beam displacer 1110B includes a pair of mirrors 1130A-B. At each mirror 1130, the optical beam 150 reflects at a right angle. Translating the mirrors 1130 in the x direction moves the point of incidence.

The beam displacers shown in FIGS. 15 are merely examples. In both of these cases, mirrors and prisms (or other types of reflective surfaces) can be substituted for each other. Furthermore, it is not necessary that the reflections occur at right angles or that the prism be a right angle prism. Other geometries can be utilized.

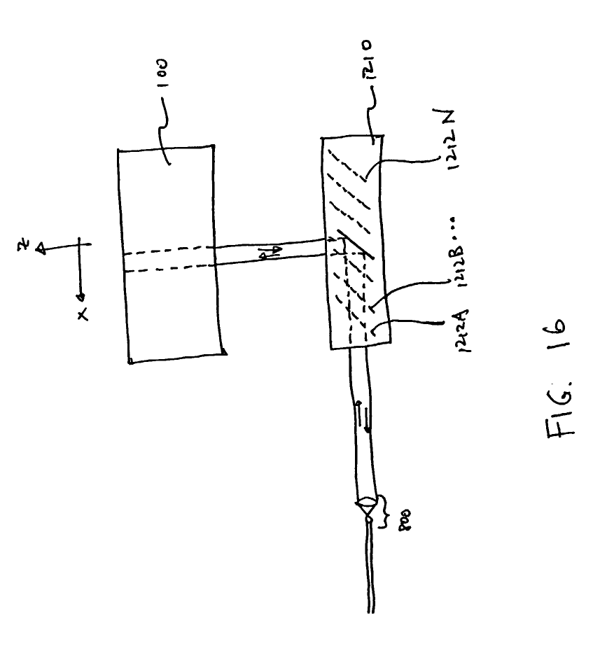

In FIG. 16, the beam displacer 1210 is a MEMS mirror. In this example, the beam displacer 1210 has a number of mirrors that can be turned on and off electrically. By turning on different mirrors, the optical beam 150 is deflected to different points of incidence. More generally, the device has a number of states, each of which directs the optical beam 150 to a different location on the etalon's front surface. Other technologies, including acousto-optics and electro-optics, can also be used.

For clarity, the figures for the above examples illustrate translation in one dimension but this is not meant to be limiting. The extension to two dimensions is straightforward. For example, FIGS. 12 and 13 depict translation by a physical actuator in one dimension. A second actuator can be added to provide translation in a second dimension. Alternately, one actuator can displace the input port in one direction, and another actuator can displace the etalon in an orthogonal direction, thus combing the two approaches in FIGS. 12 and 13. As another example, for the rotating beam displacer in FIG. 14, a second beam displacer rotating about an orthogonal axis can be added to provide two dimensional translation. Alternately, the beam displacer can be constructed so that the transparent body 1020 is rotatable about two different axes, for example by mounting the body 1020 on a gimbal.

Although the invention has been described in considerable detail with reference to certain preferred embodiments thereof, other embodiments will be apparent. Therefore, the scope of the appended claims should not be limited to the description of the preferred embodiments contained herein.

What is claimed is:

1. A dispersion compensation system for compensating for chromatic dispersion within a plurality of evenly spaced wavelength channels, the dispersion compensation system comprising:
a chain of at least one etalon stage, each etalon stage comprising:
an input port;
an output port;
an optical path from the input port to the output port; and
an etalon located in the optical path, the etalon having a front dielectric reflective coating and a back dielectric reflective coating;
wherein:
the output port of one etalon stage is optically coupled to the input port of a next etalon stage in the chain;
in at least one etalon stage, the front reflective coating of the etalon has a wavelength-dependent reflectivity that varies according to location and a point of incidence of the optical path on the front reflective coating is tunable; and
the chromatic dispersion of the chain of etalon stages substantially compensates for chromatic dispersion over an operating bandwidth within each wavelength channel and the chromatic dispersion varies over the plurality of wavelength channels.

2. The dispersion compensation system of claim 1 wherein:
the variation of chromatic dispersion over the plurality of wavelength channels is characterized by a dispersion slope; and
the chromatic dispersion of the chain of etalon stages substantially compensates for the dispersion slope.

3. The dispersion compensation system of claim 1 wherein:
the variation of chromatic dispersion over the plurality of wavelength channels is characterized by a dispersion slope; and
the chromatic dispersion of the chain of etalon stages across the plurality of wavelength channels can be tuned to substantially compensate for a range of dispersion slopes.

4. The dispersion compensation system of claim 3 wherein:
a channel spacing of the wavelength channels is defined by a ITU grid;
a free spectral range of the etalons is approximately equal to the channel spacing; and
the range of dispersion slopes includes at least −8 ps/nm² to +8 ps/nm².

5. The dispersion compensation system of claim 3 wherein, for a range of points of incidence, the wavelength-dependent reflectivity is a substantially constant function of wavelength.

6. The dispersion compensation system of claim 3 wherein, for a range of points of incidence, the wavelength-dependent reflectivity slope varies but a reflectivity offset is approximately constant at a reference wavelength.

7. The dispersion compensation system of claim 3 wherein, for a range of dispersion slopes, the chromatic dispersion of the chain of etalon stages is approximately constant at a reference wavelength.

8. The dispersion compensation system of claim 1 wherein the front reflective coating comprises:
a layer having a physical thickness that varies according to location.

9. The dispersion compensation system of claim 8 wherein the front reflective coating comprises:
a layer of constant physical thickness that is not a quarter wave thick.

10. The dispersion compensation system of claim 8 wherein the front reflective coating comprises:
a layer constructed of a material selected from the group consisting of Ta₂O₅, TiO₂, SiO₂, SiO, Pr₂O₃, Y₂O₃, Al₂O₃, HFO₂ and AlF₃.

11. The dispersion compensation system of claim 1 wherein the chain comprises at least two etalon stages.

12. The dispersion compensation system of claim 11 wherein:
a channel spacing of the wavelength channels is defined by a ITU grid;
a free spectral range of the etalons is approximately equal to the channel spacing; and
the plurality of wavelength channels includes all wavelength channels from any part of the following communications bands: the C-band (1528-1565 nm), the L-band (1565-1610 nm) and the S-band (1420-1510 nm).

13. The dispersion compensation system of claim 11 wherein:
a channel spacing of the wavelength channels is defined by a ITU grid;
the free spectral range of the etalons is approximately equal to the channel spacing; and
for at least one wavelength channel, the operating bandwidth is at least 50% of the channel spacing.

14. The dispersion compensation system of claim 1 wherein, for the at least one etalon stage, a free spectral range of the etalon in the at least one etalon stage varies according to location.

15. The dispersion compensation system of claim 14 wherein the etalon in the at least one etalon stage includes a gradient index material having an optical path length that varies according to location.

16. The dispersion compensation system of claim 14 wherein, for the etalon in the at least one etalon stage:
the wavelength-dependent reflectivity slope of the front reflective coating varies according to a first coordinate;
the free spectral range varies according to a second coordinate; and
the first coordinate and the second coordinate are orthogonal.

17. The dispersion compensation system of claim 1 wherein, for the at least one etalon stage, a phase of the optical path in the etalon is variable.

18. The dispersion compensation system of claim 1 wherein, for the at least one etalon stage:
the front reflective coating of the etalon comprises a layer having a physical thickness that varies according to a first linear coordinate;
the etalon comprises a gradient index material having an optical path length that varies according to a second linear coordinate, wherein the first linear coordinate and the second linear coordinate are orthogonal; and
the etalon stage further comprises a temperature controller coupled to the etalon for controlling a temperature of the etalon, wherein varying the temperature of the etalon varies a phase of the optical path in the etalon.

19. The dispersion compensation system of claim 1 wherein, in each of the etalon stages, the front reflective coating of the etalon has a wavelength-dependent reflectivity that varies according to location and a point of incidence of the optical path on the front reflective coating is tunable.

20. The dispersion compensation system of claim 1 further comprising:
an optical coupler for optically coupling the output port of one etalon stage to the input port of a next etalon stage in the chain.

21. The dispersion compensation system of claim 1 wherein the at least one etalon stage further comprises:
a beam displacer located in the optical path between the input port and the etalon, wherein the beam displacer varies the point of incidence of the optical path to different locations on the front reflective coating while maintaining normal incidence on the front reflective coating.

22. In a system comprising a chain of at least one etalon stage, each etalon stage including an etalon, a method for compensating for chromatic dispersion over an operating bandwidth within each of a plurality of evenly spaced wavelength channels, the method comprising:
receiving an optical beam;
in at least one etalon stage:
tuning a point of incidence of an optical path on a front reflective coating of the etalon, whereby a wavelength-dependent reflectivity of the front reflective coating is adjusted; and
propagating the received optical beam through the chain of etalon stages.

23. The method of claim 22 wherein:
the variation of chromatic dispersion over the plurality of wavelength channels is characterized by a dispersion slope; and
the chromatic dispersion of the chain of etalon stages substantially compensates for the dispersion slope.

24. The method of claim 22 wherein:
the variation of chromatic dispersion over the plurality of wavelength channels is characterized by a dispersion slope; and
the chromatic dispersion of the chain of etalon stages across the plurality of wavelength channels can be tuned to substantially compensate for a range of dispersion slopes.

25. The method of claim 24 wherein:
a channel spacing of the wavelength channels is defined by a ITU grid;
a free spectral range of the etalons is approximately equal to the channel spacing; and
the range of dispersion slopes includes at least −8 ps/nm² to +8 ps/nm².

26. The method of claim 24 wherein, for a range of points of incidence, the wavelength-dependent reflectivity is approximately constant at a reference wavelength but varies in slope.

27. The method of claim 24 wherein, for a range of dispersion slopes, the chromatic dispersion of the chain of etalon stages is approximately constant at a reference wavelength.

28. The method of claim 22 wherein the chain comprises at least two etalon stages.

29. The method of claim 28 wherein:
a channel spacing of the wavelength channels is defined by a ITU grid;
a free spectral range of the etalons is approximately equal to the channel spacing; and
the plurality of wavelength channels includes all wavelength channels from any part of the following communications bands: the C-band (1528-1565 nm), the L-band (1565-1610 nm) and the S-band (1420-1510 nm).

30. The method of claim 28 wherein:
a channel spacing of the wavelength channels is defined by a ITU grid;
the free spectral range of the etalons is approximately equal to the channel spacing; and
for at least one wavelength channel, the operating bandwidth is at least 50% of the channel spacing.

31. The method of claim 22 further comprising:
for each of the etalon stages:
tuning a point of incidence of an optical path on a front reflective coating of the etalon, whereby a wavelength-dependent reflectivity of the front reflective coating is adjusted.
